(19) United States
(12) Patent Application Publication
(10) Pub. No.: US 2012/0190406 A1
(43) Pub. Date: Jul. 26, 2012

(54) DOCKING STATION, PORTABLE DEVICE CAPABLE OF MULTIMEDIA DATA PLAYBACK MANAGEMENT, AND METHODS THEREOF

(75) Inventor: Johnny CHEN, Santa Ana, CA (US)

(73) Assignee: I O INTERCONNECT, LTD.

(21) Appl. No.: 13/335,928

(22) Filed: Dec. 22, 2011

Related U.S. Application Data
(60) Provisional application No. 61/435,631, filed on Jan. 24, 2011.

(51) Int. Cl. H04W 88/02; G06F 1/16

(52) U.S. Cl. 455/557; 361/679.41

(57) ABSTRACT

Docking stations, portable devices, and methods thereof are provided. The docking station includes an expansion port, a controller, and a transceiver. The expansion port is configured to be attached to a portable device. The controller is coupled to the expansion port and configured to determine whether the portable device is attached to the expansion port, and copy a multimedia data from the portable device to a media storage device upon the attachment. The transceiver is coupled to the controller and configured to receive a command signal from the portable device, wherein the controller is configured to control playback of the copied multimedia data in response to the command signal.

### CROSS REFERENCE TO RELATED APPLICATIONS

This Application claims priority of U.S. Provisional application Ser. No. 13/302,788, filed on Nov. 22, 2011, and U.S. Patent Application No. 61/435,631, filed on Jan. 24, 2011, and the entirety of which is incorporated by reference herein.

### BACKGROUND OF THE INVENTION

1. Field of the Invention

The present invention relates to multimedia playback, and in particular relates to a docking station and a portable device capable of managing multimedia playback.

2. Description of the Related Art

As portable computing devices becomes more and more heavily relied on by businesses and everyday users, the capabilities of the portable devices are being enhanced by external add-on devices to expand functionality while maintaining portability. Multimedia playback functionality of the portable device is favorable as the general public can play audio or video data while moving from places to places. Nevertheless, multimedia playback demands a lot of power, and portable devices are typically powered by power sources with limited power capacity such as battery cells.

### BRIEF SUMMARY OF THE INVENTION

In one aspect of the invention, a docking station is disclosed, comprising an expansion port, a controller, and a transceiver. The expansion port is configured to be attached to a portable device. The controller is coupled to the expansion port and configured to determine whether the portable device is attached to the expansion port, and copy a multimedia data from the portable device to a media storage device upon the attachment. The transceiver is coupled to the controller and configured to receive a command signal from the portable device, wherein the controller is configured to control playback of the copied multimedia data in response to the command signal.

In another aspect of the invention, a portable device is provided, docked on a docking station, capable of controlling multimedia data playback, comprising an expansion port, a controller, and a transceiver. The expansion port is configured to connect and transfer multimedia data to the docking station. The transceiver is configured to communicate with the docking station. The controller is coupled to the expansion port and the transceiver and configured to generate a command signal to playback the transferred multimedia data on the docking station, wherein the transceiver is configured to transmit the command signal to the docking station.

In yet another aspect of the invention, a method of playing multimedia data by a docking station is revealed, comprising: determining whether a portable device is attached to the docking station; copying multimedia data from the portable device to a media storage device upon the attachment; receiving a command signal from the portable device; and controlling playback of the copied multimedia data in response to the command signal.

In still another aspect of the invention, a method of controlling multimedia data playback by a portable device docked on a docking station is described, comprising: transferring multimedia data to the docking station; generating a command signal to playback the transferred multimedia data on the docking station; and transmitting the command signal to the docking station.

### BRIEF DESCRIPTION OF DRAWINGS

The invention can be more fully understood by reading the subsequent detailed description and examples with references made to the accompanying drawings, wherein:

FIG. 1 is a block diagram of a docking system 1 according to an embodiment of the invention.

FIG. 2 shows a flowchart of an exemplary multimedia playback method performed by a docking station according to an embodiment of the invention.

FIG. 3 shows a flowchart of another exemplary multimedia playback method performed by a docking station according to an embodiment of the invention.

FIG. 4 shows a flowchart of an exemplary multimedia playback method performed by a portable device according to an embodiment of the invention.

FIG. 5 shows a flowchart of another exemplary multimedia playback method performed by a portable device according to an embodiment of the invention.

FIG. 6 is a block diagram of another docking system 1 according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The USB specifications and the USB Battery Charging specifications are used to teach the spirit of the invention, and the invention is not limited thereto.

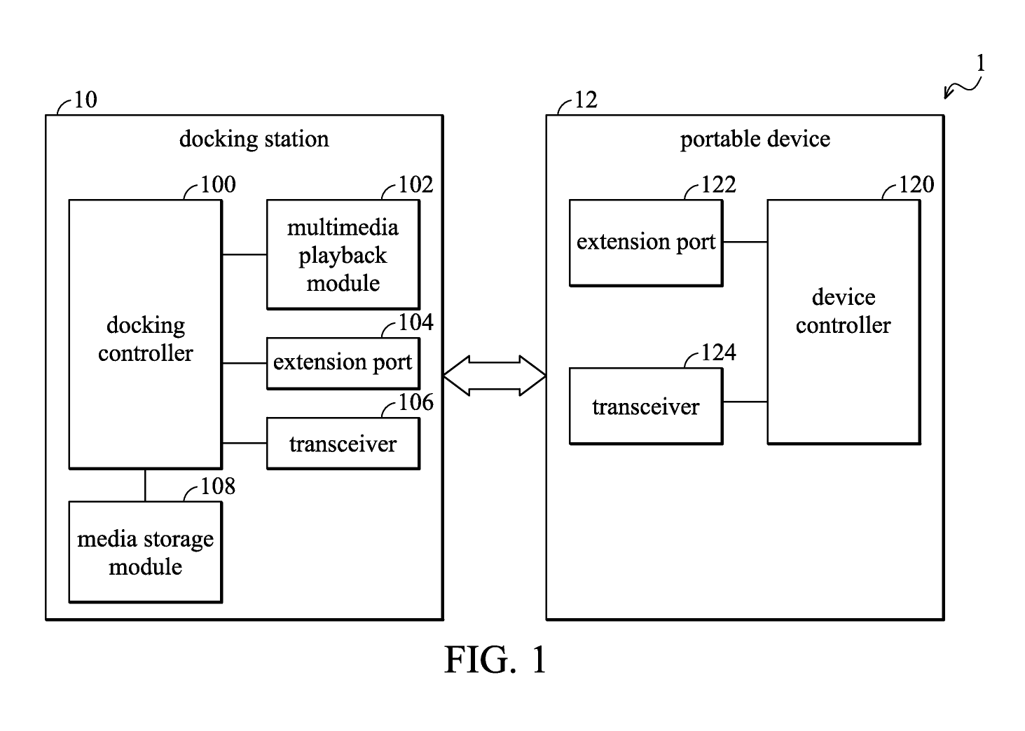

FIG. 1 is a block diagram of a cell phone docking system 1 according to an embodiment of the invention, comprising a docking station 10 and a portable device 12. The docking station 10 may be a cell phone docking cradle which bridges the portable device 12 to an added-on electronic device (not shown) such as a multimedia system, a monitor, a speaker, a media storage device, or a power adaptor to expand device functionality. The added-on electronic device may be built into the docking station 10 or may be external thereto. The docking station 10 may provide additional functionality for the portable device 12 to enhance existing functions thereon, or to restore functions that may be removed from the portable device 12 in order to increase portability. The additional functionality includes backup storage, a multimedia player, a USB hub, a battery recharger, and a game player. Typically, a docking station provides an external power source to a portable device, allowing a battery (not shown) in the portable device to be charged. The portable device 12 is a handheld computing device capable of storing multimedia data therein and relying on a battery for power supply. The portable device 12 includes a mobile phone, a personal digital assistant (PDA), a music player, a media player, a digital camera, or a tablet personal computer (PC).

Conventionally, a portable device such as a smart phone plays multimedia files including mp3 formatted music data from the local phone memory when being detached from a docking station. As the multimedia playback operation is power consuming and power capability in the portable device is limited by the battery capacity, the portable device would soon run out of the power and is needed to be recharged. In the embodiment of the present invention, the portable device 12 transfers the multimedia data to the docking station 10 when docked thereon and plays the transferred multimedia data from the docking station later, thereby conserving battery power of the portable device 12. Since the docking station 10 is connected to an external power source such as a power outlet, power is supplied to the docking station 10 constantly to carry out the power consuming playback process.

The docking station 10 acts as a backup storage that automatically searches and copies data from the docked portable device 12. The backup makes copies of data which may be used to restore the original information later. The copied data is marked with a backup ID equivalent to a device ID of the portable device 12. The device ID is unique for each portable device, therefore the docking station 10 and portable device 12 can recognize the copied data by the device ID. In some implementations, the backed up data is indexed by a timestamp or a sequence number indicative of the order in which the backed up data has been copied, for any given device 12. The docking station 10 is capable of playing back multimedia data including music data, video data, and image data from the local copied data, thereby reducing power usage in the portable device 12. When docked on the docking station 10, both the attached portable device 12 and the docking station 10 can access the backed up data and control the playback operation thereof. The playback comprises music playback, video playback, and photo playback. When being removed from the docking station 10, the detached portable device 12 functions as a remote controller to control the playback of the backed up multimedia data. In some implementations, the detached portable device 12 is only allowed to play its own multimedia backup, and is forbidden to access backed up multimedia data from other portable devices. In other implementations, the detached portable device is allowed to access and play all backed up multimedia files on the dock 10. In any case, the docking station 10 and the portable device 12 can only access the backed up multimedia data for playback.

The docking station 10 comprises a docking controller 100, a multimedia playback module 102, an extension port 104, a transceiver 106, and a storage module 108. The multimedia playback module 102, the extension port 104, the transceiver 106, and the storage module 108 are coupled to and controlled by the docking controller 100. The playback module 102 may comprise a sound speaker, a headphone piece, a playback monitor, or a combination thereof. The playback module 102 may be built-in or plug-in devices to the docking station 10. The extension port 104 may be a USB port or any other communication port, capable of connecting to the portable device when docked thereon, located in a mobile docking cradle shell (not shown) that may be secured by a retention mechanism such as a magnet, a snap, a latch, a detent, a slot, a tab, or the like. In the case of a USB port, the extension port 102 comprises hardware termination that permits detection of attachment or detachment (removal) thereat. When docked thereon, the docking station 10 exchanges wired communications with the portable device 12 and receives backed up multimedia data through the extension port 104. The transceiver 106 manages all wireless communication between the docking station 10 and the portable device 12, and may be compliant with a wireless communication protocol for a personal area network (PAN) such as Bluetooth, Infrared, WiFi, Wireless USB, Z-Wave, and ZigBee protocols, and the like. When being separated from the docking station 10, the portable device 12 exchanges wireless communication with the docking station 10 through the transceiver 106 by an adopted wireless communication technology. The transceiver 106 transmits playlist information of the backed up multimedia data to the portable device 12, so that the portable device 12 can select multimedia data to be played from. Then, the portable device 12 transmits a command signal to the docking station 10 to playback the backed up data on the docking station. The playlist information comprises a list of all multimedia data backed up on the docking station. In some implementations, the playlist information comprises only the multimedia data list associated with the portable device 12. That is, a list of all multimedia backed up data from the portable device 12. In other implementations, the playlist information comprises a list associated with any portable device that has been backed up on the docking station 10, i.e., a list of all multimedia backed up data from the portable device 12 and other portable devices. The command signal comprises a selected playlist and a device identifier of the portable device 12. The storage module 108 may be a memory device built into or external to the docking station 10. In the case of an external memory device, the storage module 108 may comprise a multi-card reader, capable of accessing data from a plurality of types replaceable memory cards such as a CompactFlash (CF), a Secure Digital (SD), a MultiMediaCard (MMC), a pen drive, or the like. The controller 100 controls data and signal flows of all connected modules and ports. Specifically, the docking controller 100 determines attachment and detachment of the portable device to the expansion port 104, copies the multimedia data from the portable device 12 to the media storage device 108 upon the attachment, establishes the playlist information to be sent to the portable device 12, and controls the playback module 102 to playback the copied multimedia data in response to the command signal received by the transceiver 106. The playlist information is established based on the copied multimedia data. In some implementations, upon reception of the command signal, the docking controller 100 compares the device ID in the command signal with the backup ID associated with the requested playback multimedia data, performs the requested playback only when the device ID and the backup ID are identical, and rejects the playback request when the device ID and the backup ID are different. In other implementations, the docking controller 100 compares the device ID with the backup ID associated with all backed up multimedia data, and proceeds with the requested playback only when the device ID matches with the one or more backup IDs of the backed up multimedia data.

The portable device 12 comprises a device controller 120, an extension port 122, and a transceiver 124. The extension port 122 and the transceiver 124 are coupled to and controlled by the device controller 120. The portable device may be used as a remote control, controlling the playback of the backed up multimedia data on the docking station 10. Similar to the extension port 104 in the docking station 10, the extension port 122 may be a USB port or any other communication port, managing all wired communication to the docking station 10, and is compatible with the extension port 104. The transceiver 124 is compatible with the transceiver 106, and capable of managing all wireless communication between the docking station 10 and the portable device 12. The description of the extension port and the transceiver are provided in the preceding section and will not be repeated again for brevity. The extension port 122 transfers the multimedia data to the docking station 10 for backup upon attachment. The device controller 120 controls data and signal flows of all components in the portable device 12. After receiving the playlist information from the docking station 10, the device controller 120 selects multimedia files therefrom to generate the command signal to playback the transferred multimedia data on the docking station, and controls the transceiver 124 to transmit the command signal through a communication protocol. The command signal comprises selected multimedia data and the device ID of the portable device.

The embodiment of the invention backs up the multimedia data on the portable device 12 to the docking station 10, and carries out the playback only based on the backed up multimedia data, thereby reducing power usage and increasing battery life of the portable device.

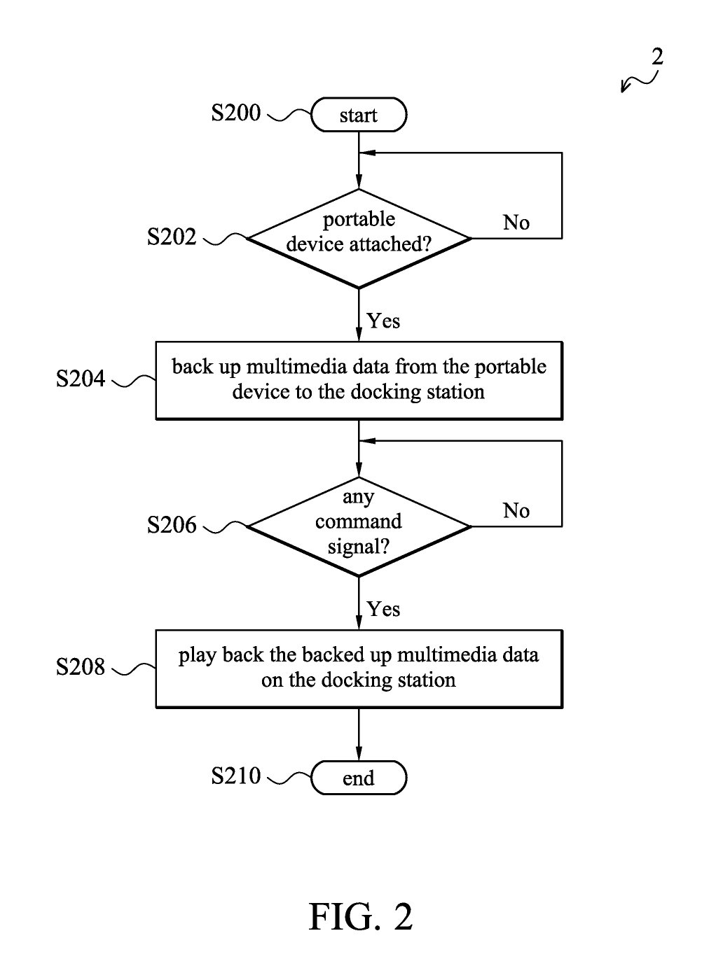

FIG. 2 shows a flowchart of an exemplary multimedia playback method 2 performed by a docking station according to an embodiment of the invention, incorporating the docking system 1 in FIG. 1. Upon startup, the docking station 10 is initialized to detect attachment of any docked portable device for the data backup (S200). The device controller 120 determines whether a portable device has been attached via the detection at the extension port 104 (S202). Upon being docked-on, the extension port 104 detects the presence of the portable device 12 by hardware detection or software detection. For hardware detection, the extension port 104 detects the attachment and detachment of the portable device 12 by signal levels at the termination of the extension port 104. For software detection, the extension port 104 receives a message from the portable device 12 informing of the presence of the portable device 12. If the portable device 12 is attached, the docking station 10 initiates a backup operation for the multimedia data on the portable device 12 (S204). If the portable device 12 is not attached, the device controller 120 waits for the detection at the extension port 104 until the portable device 12 is connected (S202). The device controller 120 copies data from a memory (not shown) of the portable device 12 to the storage module 108 as backup data, and generates the timestamp or the sequence number indicating a version of the backup data. In some implementations, the docking controller 100 checks whether the data on the portable device 12 has been changed since the last backup operation, and only performs the copying operation if the data has been modified. The device controller 120 receives and saves the device ID of the portable device 12 as the backup ID of the backup data. The backup data is multimedia data that may be played by the multimedia playback module 102. After the backup is completed, the portable device 12 may be removed from the docking station 10 and functions as a remote control for the docking station 10. The docking station 10 determines whether the command signal from the portable device 12 is received through the transceiver 106 (S206). The command signal comprises a list of selected multimedia data and the device ID of the portable device 12. If a command signal is detected, the docking controller 120 plays back the backed up multimedia data (S208), and waits for a command signal if not (S206). In some implementations, the docking controller 120 further determines whether the device ID matches to the backup ID of the selected data, and only allows the playback if so. After the selected playback, the multimedia playback method 2 is then completed and exited (S210).

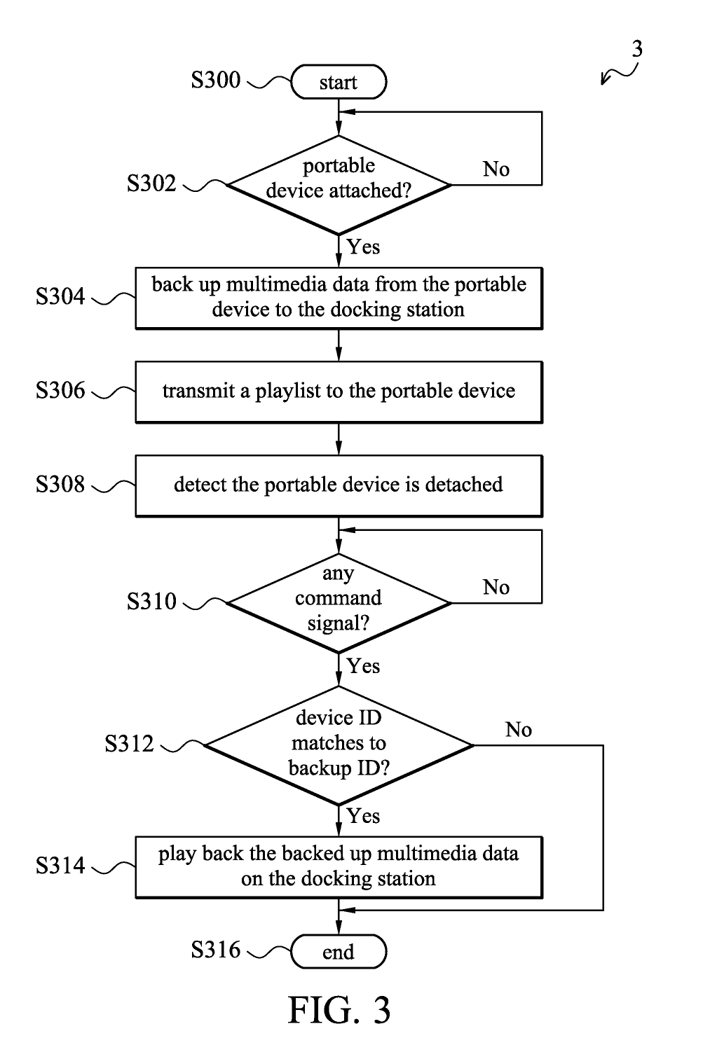

FIG. 3 shows a flowchart of another exemplary multimedia playback method performed by a docking station according to an embodiment of the invention, incorporating the docking system 1 in FIG. 1. Steps 300-304 are identical to Step S200-204, and relevant explanation thereof can be found in the preceding description. After the multimedia data are backed up, the docking controller 120 establishes a playlist based on backed up multimedia data in the storage module 108 and sends the playlist information to the portable device 12 (S306). In some implementations, the docking controller 120 establishes the playlist based on all backed up data for the specific portable device 12. For example, the docking controller 12 determines the playlist by accumulating the backed up data comprising a same backup ID into a list. In other implementations, the docking controller 120 computes the playlist using all backed up data in the storage module 108, irrespective of the original backup device. For example, the docking controller 12 determines the playlist by collecting all backed up data stored in the storage module 108 into a list without checking the backup IDs. The docking station 10 may transmit the playlist information to the portable device 12 when being docked or after being undocked. When docked, the playlist is transferred to the portable device 12 through the extension port 104. When undocked, the playlist is transferred to the portable device 12 through the transceiver 106. The docking controller 100 determines the removal of the portable device 12 by the voltage levels on the termination of the extension port 102 (S308), and retrieves the command signal from the portable device 12 to perform the requested audio, video, or image playback (S310). Upon retrieval of the command signal, the docking controller 12 extracts the device ID information therefrom, compares the retrieved device ID with the backup ID of the requested backed up data, and determines whether the two IDs match to each other (S312). If so, the docking controller 12 loads the requested multimedia data from the storage module 108 for playing on the multimedia playback module 102 (S314), and if not, the docking controller 12 returns a reject message to the portable device, and exits the playback procedure 3 (S316). After the requested multimedia playback is finished, the playback method 3 is completed and exited (S316).

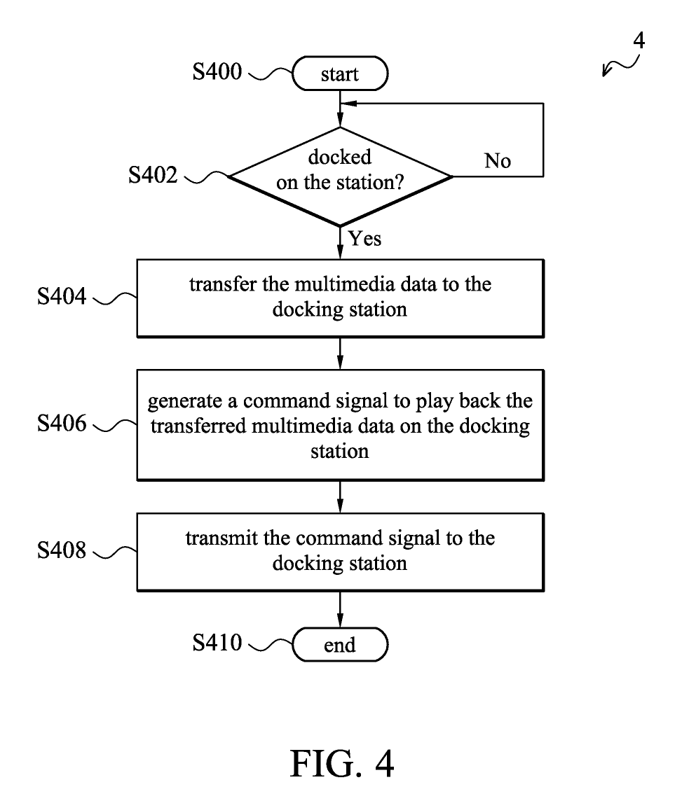

FIG. 4 shows a flowchart of an exemplary multimedia playback method performed by a portable device according to an embodiment of the invention, incorporating the docking system 1 in FIG. 1. Upon startup, the portable device 12 determines whether it is coupled to the docking station 10 through the extension port 122 (S402). Similar to the attachment detection in Step S202 in FIG. 2, the extension port 122 may indicate the connection status by the software or hardware detection, and details thereof can be found in the explanation for Step S202. Upon the attachment, the portable device 12 transfers the multimedia data and the device ID to the docking station 10 for backup (S404). When no portable device is attached, the portable device 12 returns to Step S402 to determine the connection status. The device controller 120 generates the command signal to control the playback of the backed up multimedia files on the docking station 10 (S406). The command signal comprises a list of requested playback files and the device ID of the portable device 12. The multimedia playback is performed by the docking station 10 to reduce power consumption at the portable device 12. Next, the portable device 12 requests for the multimedia playback by transmitting the command signal to the docking station 10 (S408), thus completing the multimedia playback method 4.

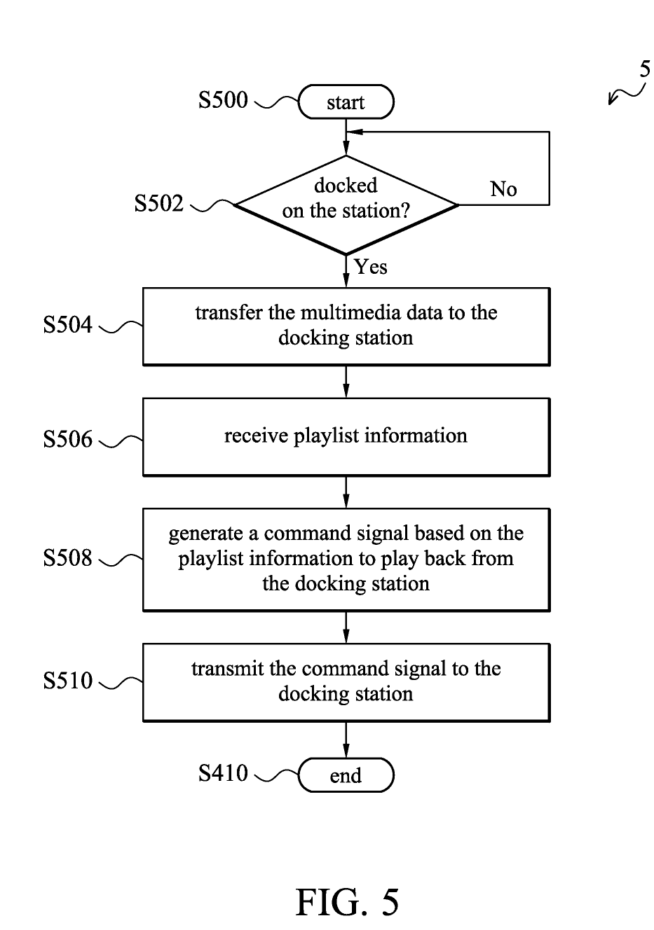

FIG. 5 shows a flowchart of another exemplary multimedia playback method performed by a portable device according to an embodiment of the invention, incorporating the docking system 1 in FIG. 1. Steps S500 to S504 are identical to Steps S400-S404, and the details of the steps can be found in the preceding paragraph. After the data on the portable device 12 is transferred to the docking station 10 for the backup, the portable device receives playlist information indicative of a list of backed up multimedia files that can be selected from the docking station 10 (S506). Accordingly, the portable device 10 can generate a command signal based on the received multimedia file list (S508), and sends the command signal to the docking station 10 to request for the multimedia playback. Similar to Step S406, the command signal comprises a list of requested playback files and the device ID of the portable device 12. The multimedia playback method is then completed and exited.

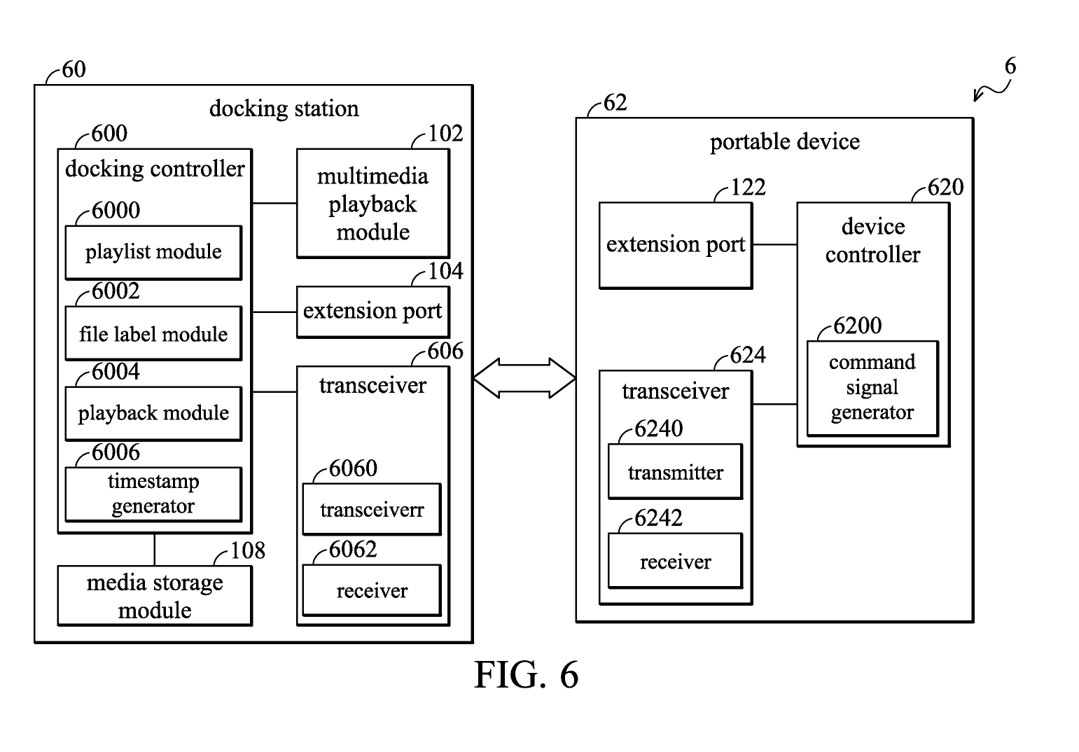

FIG. 6 is a block diagram of another docking system 1 according to an embodiment of the invention, comprising a docking station 60 and a portable device 62. The circuit configuration and connection is identical to those in the docking system in FIG. 1, reference therefor can be found in the preceding paragraphs and will not be repeated here for brevity.

The portable device 64 is able to connect to the docking station 60 via the extension port 104. The docking controller 600 is coupled to the expansion port 104, and is configured to determine whether the portable device 62 has been attached to the expansion port 104. Upon detecting the attachment of the portable device 64, the docking controller 600 copies the multimedia data as a backup from the portable device 64 to the media storage module 108 in the docking station 60. The transceiver 606 is configured to receive a command signal from the portable device 64. In response to the received command signal, the controller 600 controls the multimedia playback module 102 to play the backed up multimedia data.

The docking controller 600 may further comprise a playlist module 6000, configured to establish playlist information based on the copied multimedia data, which comprises. The command signal may contain a part of the playlist information, for examples, a list of songs to be played from the docking station 60. The transceiver 606 comprises a transmitter 6060 and a receiver 6062. The transmitter 6060 is configured to transmit the playlist information to the portable device 64. During the multimedia backup, the receiver 6062 receives a backup identifier identifying the portable device 64. In response, the controller 600 is configured to associate the backup identifier with the copied multimedia file via a file label module 6062 therein. In some implementations, the command signal comprises a portable device identifier identifying the portable device 64. The docking controller 600 may further comprise a playback module 6004, configured to playback the copied multimedia only when the portable device identifier matches to the associated backup identifier. Moreover, the docking controller 6000 may comprise a timestamp generator 6006, configured to generate a timestamp associated with the copied multimedia data.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine.

The various storage or memory device described in the present disclosure may be realized by Flash memory, Dynamic Random Access Memory (DRAM), Static Random Access Memory (SRAM), Synchronized Dynamic Random Access Memory (SDRAM), Double Data Rate 2 (DDR2) RAM or Rambus Dynamic Random Access Memory (RDRAM), Non-Volatile Random Access Memory (NVRAM), Magnetic Random Access Memory (MRAM) or any other type of memory. The various storage or memory devices also comprises disk drive, Digital Video Disk (DVD) drive, Compact Disk (CD) drive, Redundant Array of Independent Disks (RAID), tape drive or other media storage device.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A docking station, comprising:
an expansion port, configured to be attached to a portable device;
a controller, coupled to the expansion port, configured to determine whether the portable device is attached to the expansion port, and copy a multimedia data from the portable device to a media storage device upon the attachment; and
a transceiver, coupled to the controller, configured to receive a command signal from the portable device;
wherein the controller is configured to control playback of the copied multimedia data in response to the command signal.

2. The docking station of claim 1, wherein:
the controller further comprises a playlist module, configured to establish playlist information based on the copied multimedia data;
the transceiver comprises a transmitter, configured to transmit the playlist information to the portable device; and
the command signal comprises a part of the playlist information.

3. The docking station of claim 1, wherein the transceiver comprises a receiver, configured to receive a backup identifier identifying the portable device; and
controller further comprises a file label module, configured to associate the backup identifier with the copied multimedia file.

4. The docking station of claim 3, wherein the command signal comprises a portable device identifier identifying the portable device, and the controller comprises a playback module, configured to playback the copied multimedia only when the portable device identifier matches to the associated backup identifier.

5. The docking station of claim 1, wherein the controller further comprises a timestamp generator, configured to generate a timestamp associated with the copied multimedia data.

6. A portable device, docked on a docking station, capable of controlling multimedia data playback, comprising:
an expansion port, configured to connect and transfer multimedia data to the docking station;
a transceiver, configured to communicate with the docking station; and
a controller, coupled to the expansion port and the transceiver, configured to generate a command signal to playback the transferred multimedia data on the docking station,
wherein the transceiver is configured to transmit the command signal to the docking station.

7. The portable device of claim 6, wherein the transceiver comprises a receiver, configured to receive playlist information associated with the transferred multimedia data from the docking station; and
the controller further comprises a command signal generator, configured to generate the command signal based on the received playlist information.

8. The portable device of claim 6, wherein the transceiver comprises a transmitter, configured to transmit a backup identifier identifying the portable device to the docking station.

9. The portable device of claim 6, wherein the command signal comprises a portable device identifier identifying the portable device.

10. A method of playing multimedia data by a docking station, comprising:
determining whether a portable device is attached to the docking station;
copying a multimedia data from the portable device to a media storage device upon the attachment;
receiving a command signal from the portable device; and
controlling playback of the copied multimedia data in response to the command signal.

11. The method of claim 10, further comprising removing the portable device from the docking station.

12. The method of claim 10, further comprising:
establishing playlist information based on the copied multimedia data; and
transmitting the playlist information to the portable device;
wherein the command signal comprises a part of the playlist information.

13. The method of claim 10, further comprising receiving a backup identifier identifying the portable device, and associating the backup identifier with the copied multimedia file.

14. The method of claim 13, wherein the command signal comprises a portable device identifier identifying the portable device, and the playing back step comprises playing back the copied multimedia only when the portable device identifier matches to the associated backup identifier.

15. The method of claim 10, further comprising generating a timestamp associated with the copied multimedia data.

16. A method of controlling multimedia data playback by a portable device docked on a docking station, comprising:
transferring multimedia data to the docking station;
generating a command signal to play back the transferred multimedia data on the docking station; and
transmitting the command signal to the docking station.

17. The method of claim 16, further comprising receiving playlist information associated with the transferred multimedia data from the docking station, and the generating step comprises generating the command signal based on the received playlist information.

18. The method of claim 16, further comprising transmitting a backup identifier identifying the portable device to the docking station.

19. The method of claim 16, wherein the command signal comprises a portable device identifier identifying the portable device.
